(19) United States
(12) Patent Application Publication
(10) Pub. No.: US 2011/0307491 A1
(43) Pub. Date: Dec. 15, 2011

(54) DIGITAL PHOTO ORGANIZING AND TAGGING METHOD

(76) Inventor: CHARLES M. FISK, San Antonio, TX (US)

(21) Appl. No.: 13/217,106

(22) Filed: Aug. 24, 2011

Related U.S. Application Data
(63) Continuation-in-part of application No. 12/365,860, filed on Feb. 4, 2009.

(51) Int. Cl. G06F 17/30

(52) U.S. Cl. 707/741; 707/E17.004

(57) ABSTRACT

The digital photo organizing and tagging method includes software and a database that organizes digitized versions of dispersed collections of images such as photographs, pictures and other graphical objects from a variety of sources. The method facilitates describing, resizing, indexing, and sorting the different aspects contained in images. Features include documentation, e-mail, updating, version control, inclusion of video, embellishment, sound, animation, text to speech and, dynamic search. An Internet application facilitates annotation, organization, researching and sharing images and corresponding information collected at different times and places. Desktop/Internet applications link and relate images that share common elements. The same person found as a child in one image, as an adult in another, and referenced in a newspaper article is a relation example. The method collects the knowledge embedded in multiple images and produces well documented, organized, and clearly explained printable images, as well as dynamic albums of related images.

### CROSS-REFERENCE TO RELATED APPLICATION

This application is a continuation-in-part of my prior U.S. patent application Ser. No. 12/365,860, filed Feb. 4, 2009.

### BACKGROUND OF THE INVENTION

1. Field of the Invention

The present invention relates to Internet photo organizers, and particularly to a digital photo organizing and tagging method that interactively describes, organizes, searches, and shares images uploaded by users.

2. Description of the Related Art

People have collections of photographs dispersed in shoeboxes, albums, electronic storage, or other media. The saying “a picture is worth a thousand words” is misleading; a picture without words becomes harder to understand with the passing of time. Problems present themselves in the form of questions concerning who is in the picture, where, why and when was the picture taken. Oftentimes such questions remain unanswered and valuable information is lost.

Thus, a digital photo organizing and tagging method solving the aforementioned problems is desired.

### SUMMARY OF THE INVENTION

The digital photo organizing and tagging method has interactive downloadable and online tools that facilitate describing, organizing, and researching images collected at different times, in different places. Images sharing similar components are linked and related to each other. For example, when images concerning a certain person are linked related using the interactive online tools of the image component web/pc database, the same person found as a child in one image, as an adult in another, and as referenced in a newspaper article are seamlessly linked together. The methodology of linking person images and references is similar to that of relating tables having common attributes in a relational database.

The digital photo organizing and tagging method allows a user to collect the knowledge of many people to produce well documented, organized and clearly explained picture albums.

The method extends the social information explosion brought about by well-known social networking sites. An e-mail application is provided so that users can e-mail images and the information about the images first to friends and family who arc better equipped to add content including new related images. Moreover, the documented images arc optionally stored in a central web database so that any person can search and add new discovery. Images may be retrieved and displayed in predetermined patterns based on random key selections from the central web database.

These and other features of the present invention will become readily apparent upon further review of the following specification and drawings.

### BRIEF DESCRIPTION OF THE DRAWINGS

FIG. 1 is a block diagram showing picture objects exchanged electronically from user to user in a digital photo organizing and tagging method according to the present invention.

FIG. 2 is a flowchart showing the process for creating new Image Objects in a digital photo organizing and tagging method according to the present invention.

FIG. 3 is a screen shot showing presentation of Image Object and annotation in a browser in a digital photo organizing and tagging method according to the present invention.

FIG. 4A is a screen shot showing Image Object and story pulldown menu in a digital photo organizing and tagging method according to the present invention.

FIG. 4B is a block diagram showing Image Object story entry form after Write About was selected in the menu of FIG. 4A.

FIG. 5 is a block diagram showing a section of the screen surrounded by a resizable frame, which enables information entry for the highlighted area in a digital photo organizing and tagging method according to the present invention.

FIG. 6 is a screen shot showing the frame with a submenu that enables additional commands pertinent to the frame itself in a digital photo organizing and tagging method according to the present invention.

FIG. 7 is a block diagram showing how users can mark small areas to reduce the frame size to a single dot in a digital photo organizing and tagging method according to the present invention.

FIG. 8 is a block diagram showing how the story application places markings on the edge of the picture to facilitate identification of image components in a digital photo organizing and tagging method according to the present invention.

FIG. 9 is a screen shot showing how an index to all the annotated image aspects is provided to allow easy identification of the annotated areas in a digital photo organizing and tagging method according to the present invention.

FIG. 10 is a block diagram showing how the computer displays all the information added to the image including bold names that are clickable to display the annotated image area in a digital photo organizing and tagging method according to the present invention.

FIG. 11 is a block diagram showing the drop cap embellishment options in a digital photo organizing and tagging method according to the present invention.

FIG. 12 is a block diagram showing how a designated animation character uses text to speech in a digital photo organizing and tagging method according to the present invention.

FIG. 13 is a block diagram showing the Forms interface corresponding to the Album Generator in a digital photo organizing and tagging method according to the present invention.

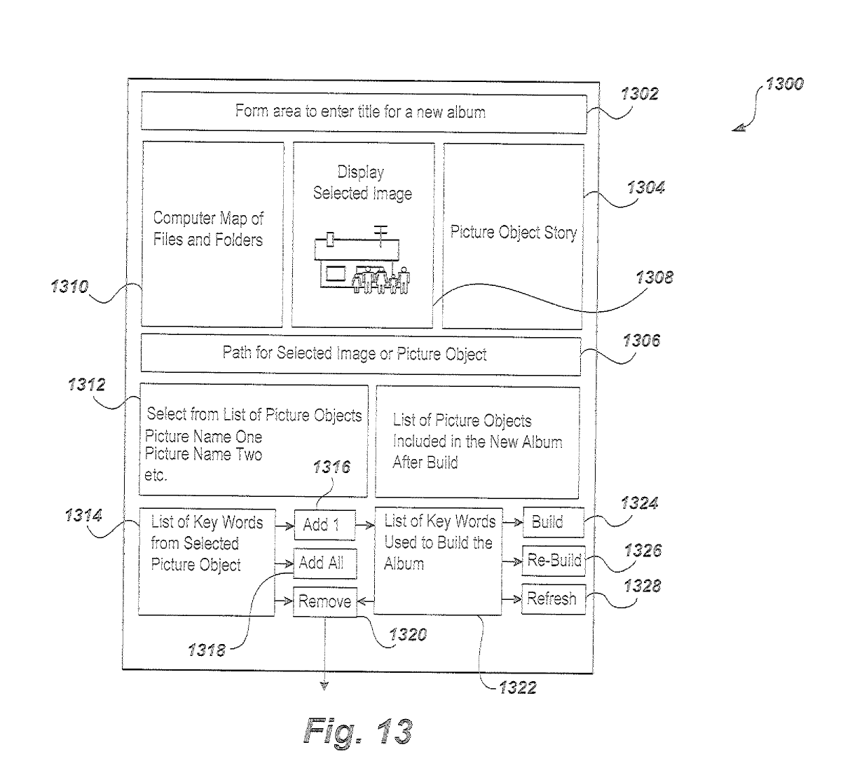

FIG. 14A is a screen shot showing “search” and “related” pushbuttons in a digital photo organizing and tagging method according to the present invention.

FIG. 14B is a screen shot showing the search popup in a digital photo organizing and tagging method according to the present invention.

FIG. 14C is a screen shot showing thumbnail portion of search results in a digital photo organizing and tagging method according to the present invention.

FIG. 14D is a screen shot showing index portion of search results in a digital photo organizing and tagging method according to the present invention.

FIG. 15 is a block diagram showing the Image Object displaying video in the bottom left hand corner in a digital photo organizing and tagging method according to the present invention.

FIG. 16 is a block diagram showing a section of the help manual displayed over the Image Object in a digital photo organizing and tagging method according to the present invention.

FIG. 17 is a block diagram showing a conceptual view of the Image Object database in a digital photo organizing and tagging method according to the present invention.

FIG. 18 is a simulated screen shot showing a randomized thumbnail search return in the form of dominos in a digital photo organizing and tagging method according to the present invention.

FIG. 19 is a block diagram showing examples of how the system-web server supports Internet users in multiple ways in a digital photo organizing and tagging method according to the present invention.

FIG. 20 is a block diagram showing server-PC interfaces in a digital photo organizing and tagging method according to the present invention.

Similar reference characters denote corresponding features consistently throughout the attached drawings.

### DETAILED DESCRIPTION OF THE PREFERRED EMBODIMENTS

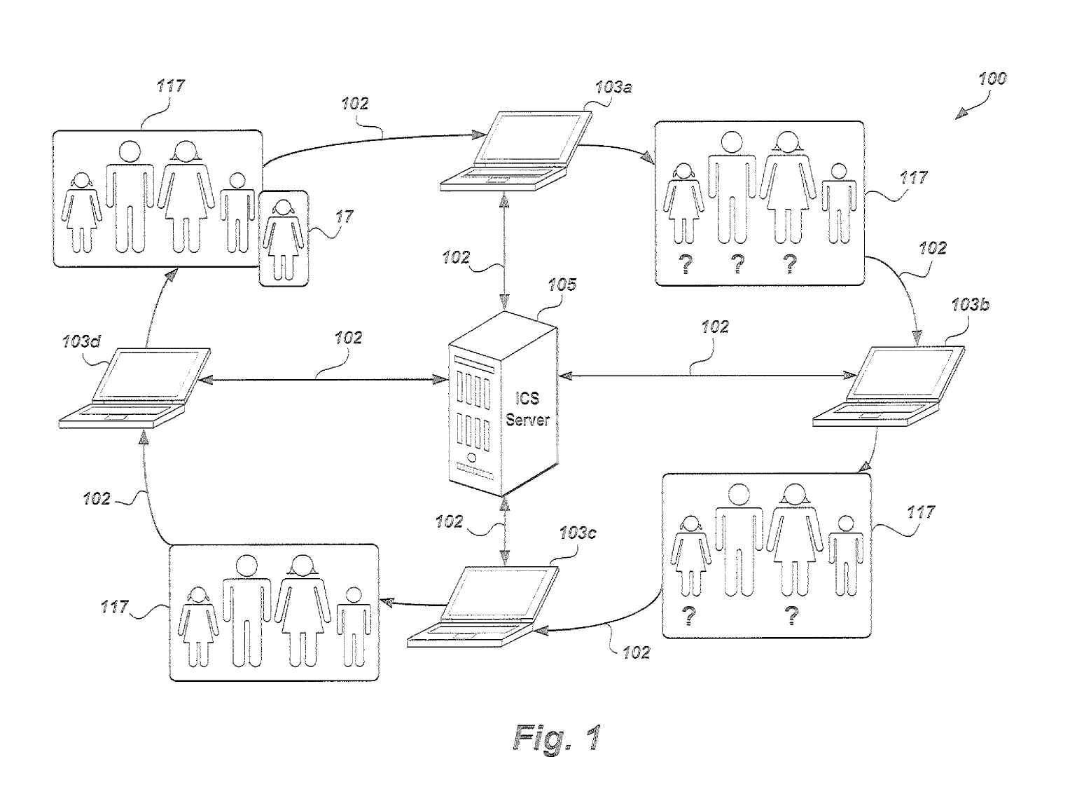

As shown in the diagram 100 OF FIG. 1, the digital photo organizing and tagging method can have at least one system server 105 connected to the Internet 102. System server 105 is the central location accessible from the Internet 102, and provides the necessary applications, interfaces, and the like, to interact with a user's personal computing device, e.g., Web-enabled devices 103a, 103b, 103c, or 103d. Image objects 117 can be shared among users of the Web-enabled devices 103a, 103b, 103c, and 103d. Given adequate permissions, a user can add a digital photo 17 to the original image object 117.

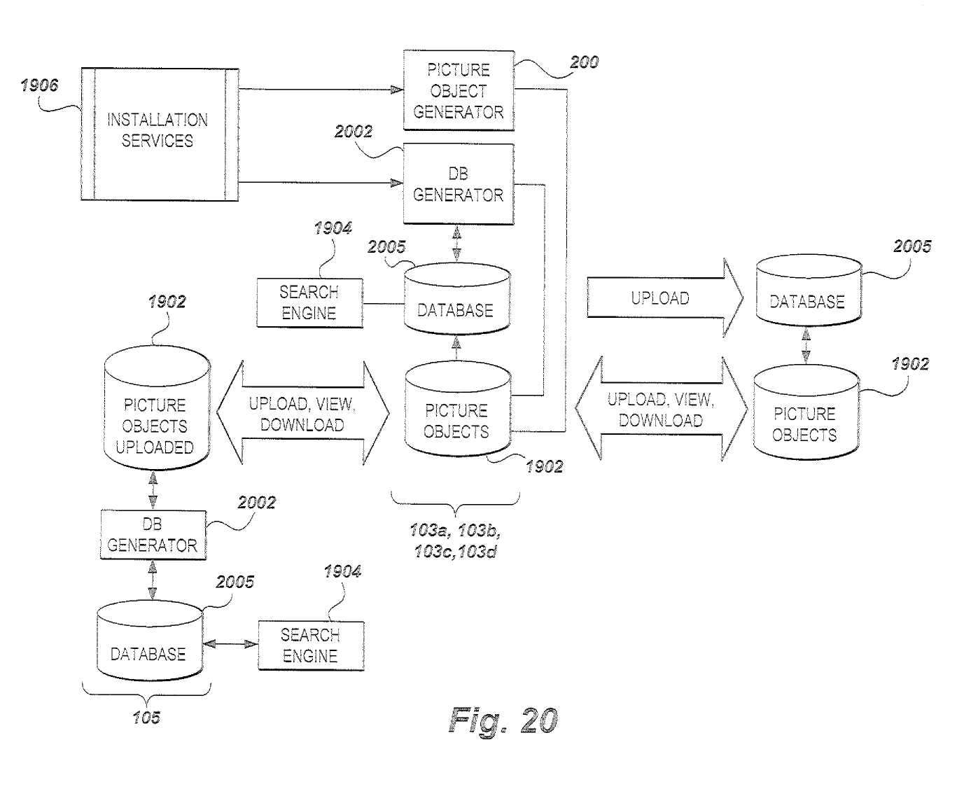

As shown in FIG. 20, member information can be stored in a database 2005 when it is resident on system server 105. Image Objects generated and maintained by the image object generator are resizable, allow for descriptions, embellishments, component identification, and become searchable and. shareable by multiple users connected to the Internet. The Image Object 1902 allows the user to highlight, resize, and describe the different things that appear in the selected image.

The member information is then accessible to system server 105. The Internet 102 allows for remote support of the inventive photo organizing method available on authorized users' remote personal computing devices. The server's connection to the Internet 102 allows for communication between the server 102 and a base of user devices, such as Web-enabled devices 103a, 103b, 103c, and 103d. Individuals connect to the server 105 via the Internet 102 to search, upload, and download image (picture) objects 2008.

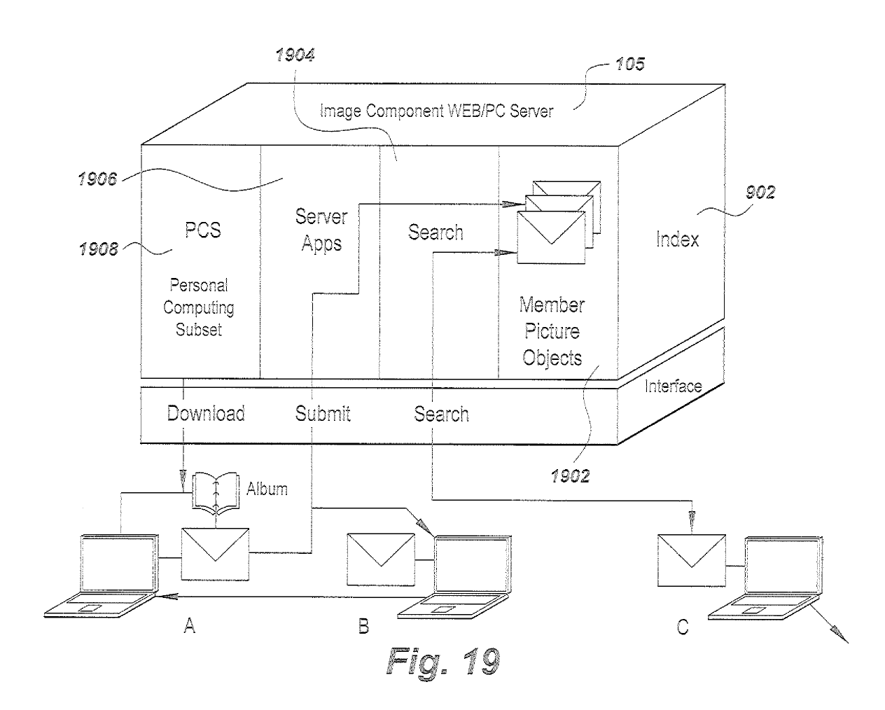

The database portion of server 105 stores Image Objects in corresponding member directories. As shown in FIG. 19, an index 902 of image object keys can be extracted from the Image Objects to facilitate searching of the picture objects 1902. A database search engine 1904 (shown in FIGS. 19 and 20) searches and links images that share common elements as dictated by search criteria input by the user.

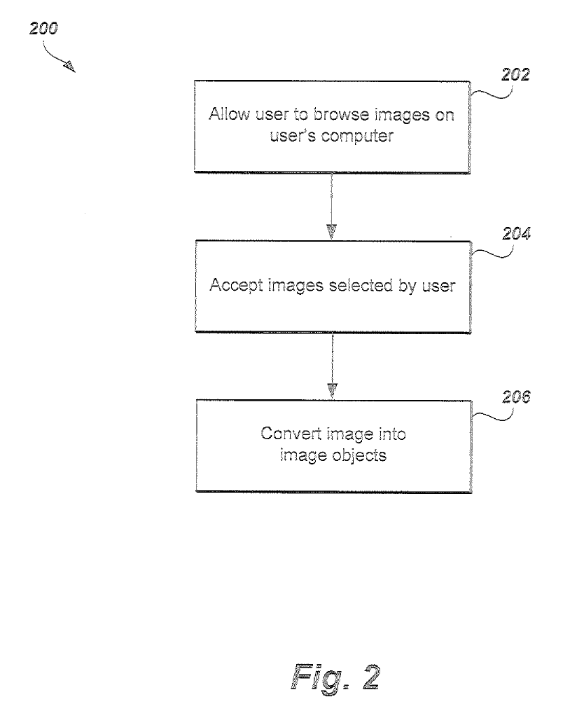

Server 105 contains a separate personal computing subset 1908 (PCS) suite of applications, which facilitate stand-alone image management operations on a personal computing device. The system server 105 may have installation services 1906 and may also serve up web pages associated therewith. The stand-alone image management software 1908 can be downloaded from and maintained by installation services 1906. At least one auxiliary server 2000 may also include database 2005 filled with picture objects 1902 and be accessible by process 200 (shown in FIG. 2) running on a user's Web-enabled device (e.g. 103a 103b, 103c, or 103d) for uploading, viewing, and downloading of the picture objects 1902.

Individuals have the option to install software implementing functionality of the digital photo organizing and tagging method on a personal computer without the need of becoming members of the web server; in this ease, the users retain all the organizational facilities of the invention with the ability to share information on the Internet using e-mail. The personal computing subset 1908 provides applications that facilitate browsing within the user's personal computer, select images and convert them into Image Objects as shown in FIG. 2. The PCS software 1908 executes method steps (most clearly shown in FIG. 2), which include method step 202 that allows the user to browse images on the user's computer, method step 204 that accepts images selected by the user, and method step 205 that converts the image into image (picture) objects. Moreover, the personal computing subset 1908 (shown in FIGS. 19 and 20) provides tools to create new albums and add new instances of Image Objects 1902.

As shown in Fig, 13, at least one web page 1300 has a form area 1302 to enter new album title. A user selected image object may be displayed in form area 1308. A picture object story area 1304 is provided for entry of narrative regarding the image object displayed in selected area 1308. An iconic directory 1310 of files containing image objects 1.902 is also provided on the page 1300.

There is also a field 1306 displaying the path for the selected image object. A list of picture objects displayed in screen area 1312 may be selected. A. keyword list 1314 is displayed from the selected picture object. “Add 1” 1316 “Add all 1318” or “Remove 1320” buttons may be selected to build key word list 1322 that is used to build the album. Once the user is satisfied with the album build keys 1322, the user selects Build 1324, Re-Build 1326, or Refresh 1328 to accomplish building the album with the image objects specified by the album selection criteria specified by build keys 1322.

It should be understood that the aforementioned layout on page 1300 is exemplary only and could be done in a variety of ways. For example, selecting a provided “Relate” button and a provided “Search” button can be made to cause the server 105 to use all aspects tagged in the selected current image object and look for other images that have at least one common aspect, i.e., matching keys, to thereby create a picture album having the required search criteria.

The system server 105 has a database index that retains all the identified key names of objects submitted to the server 105, including images, image parts, member names, and folder locations. The system server 105 and applications installed by PCS installation services 1906 maintain a history of changes made to Image Objects 1902. Newly submitted image data is accepted by the system which automatically launches a system server search for other images that contain aspects related (according to search criteria) to the new data. The server utilizes an application that e-mails the search results to the owner of the image. Moreover, the e-mail application allows users to send updates or exchange information with other image owners.

The Picture or Image Object 1902 encapsulates the image, its overall description, and applications to view, maintain, and update the Image Object plus the ability to create new objects.

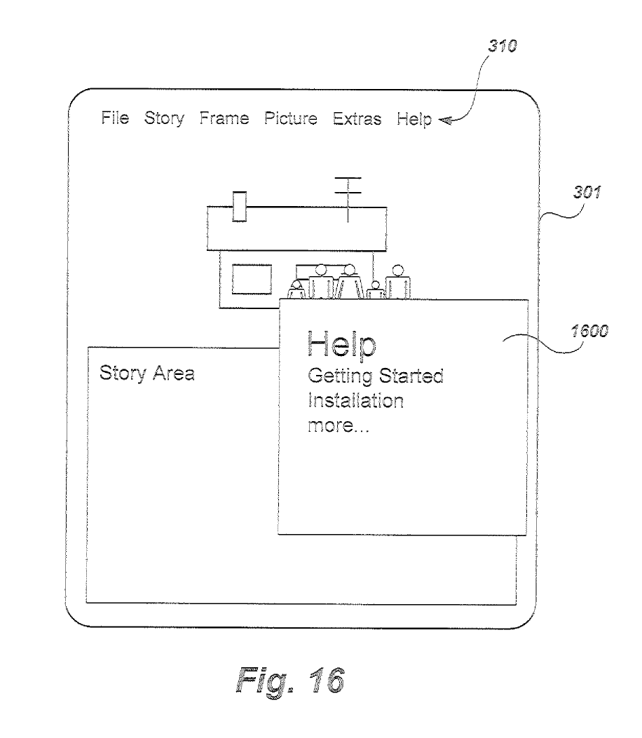

The digital photo organizer also includes a Help tool pop-up window 1600 (shown in FIG. 16) that guides the user throughout the process.

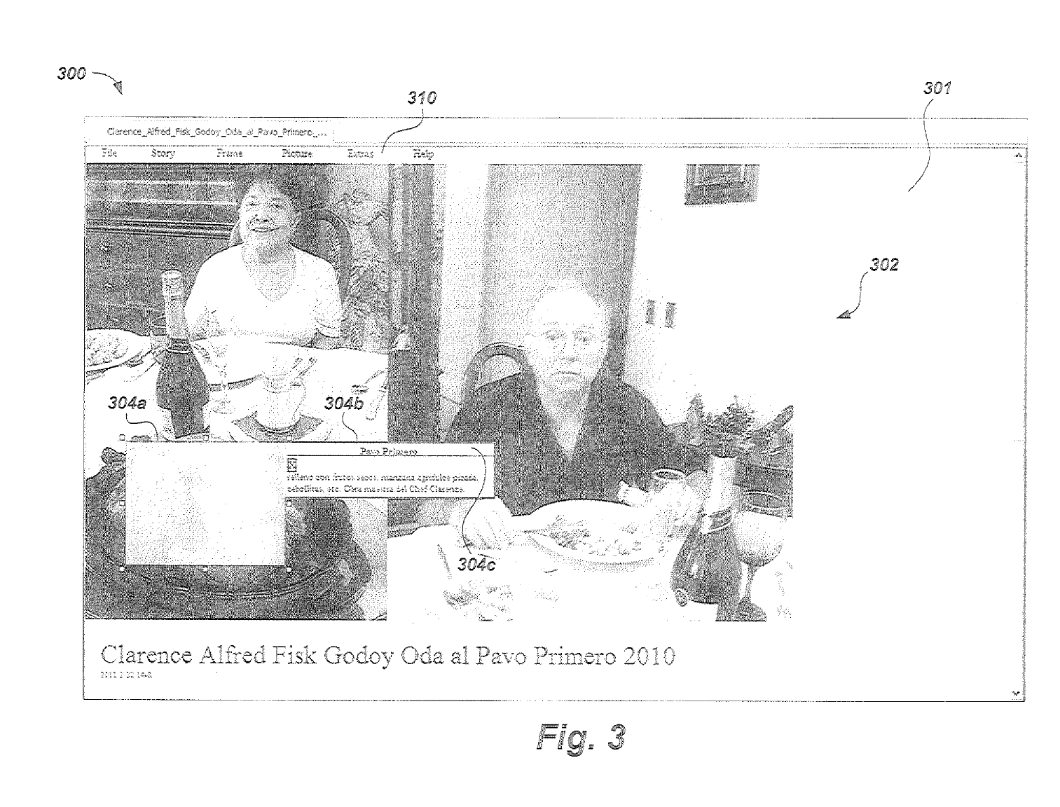

As shown in FIG. 3, a digital image 302 can be displayed inside a web browser 300. A blank area 301 is reserved for text, pop=up menus, and the like, A menu bar 310 is provided to perform the various functions of the digital photo organizing and tagging method.

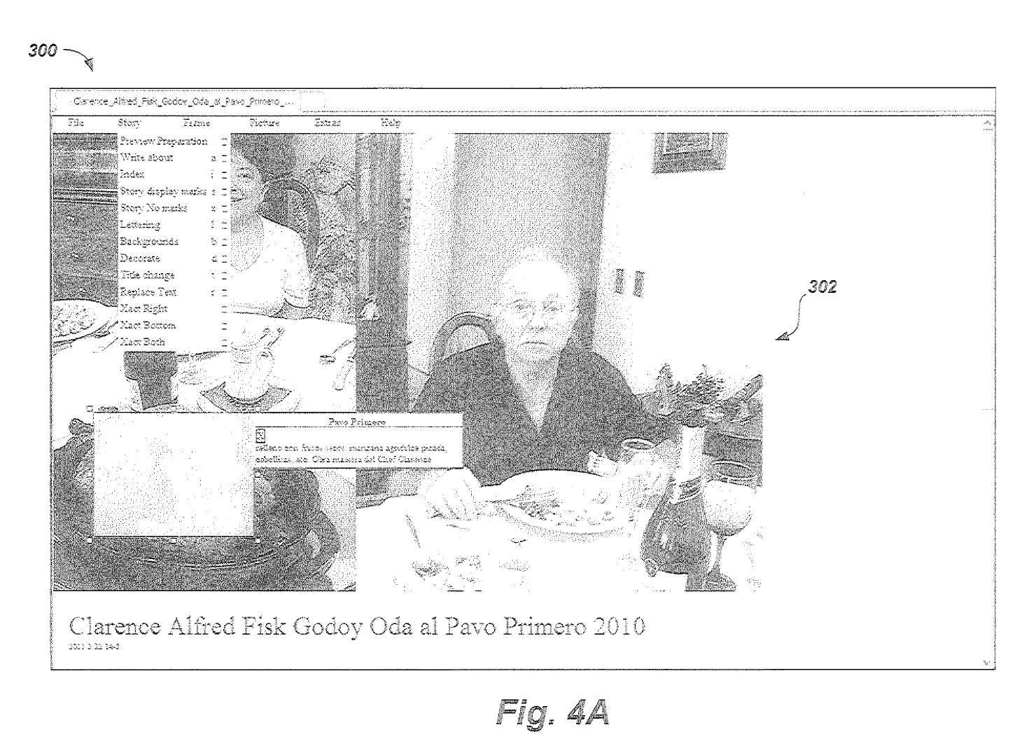

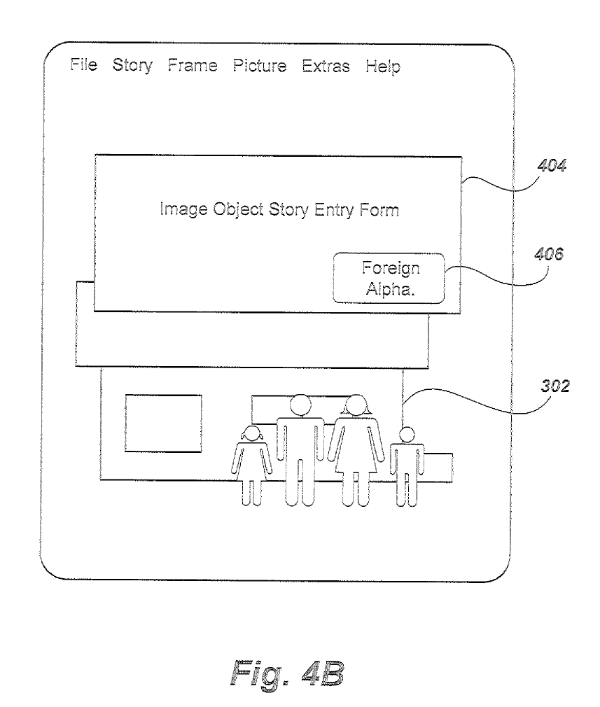

When the user mouses over a previously identified item inside of the image 302, a semi-opaque, predefined bounding box 304a encapsulates the identified item. Descriptive text 304c of the user-identified item bounded by box 304a is displayed inside a description text box 304c. As shown in FIG. 4A, the descriptive text preparation can be initiated from the Story menu item 999. When so initiated, as shown in Fig, 413, an entry form 404 is provided for entry of the description of image 302. A foreign alpha button 406 is also provided and is used to implement foreign character tools that allow the user to insert foreign characters when they are not available in the keyboard or keypad.

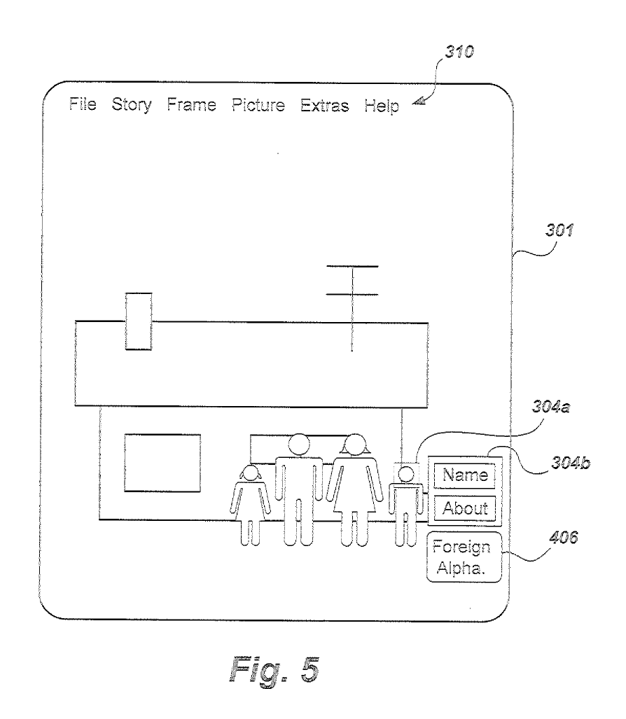

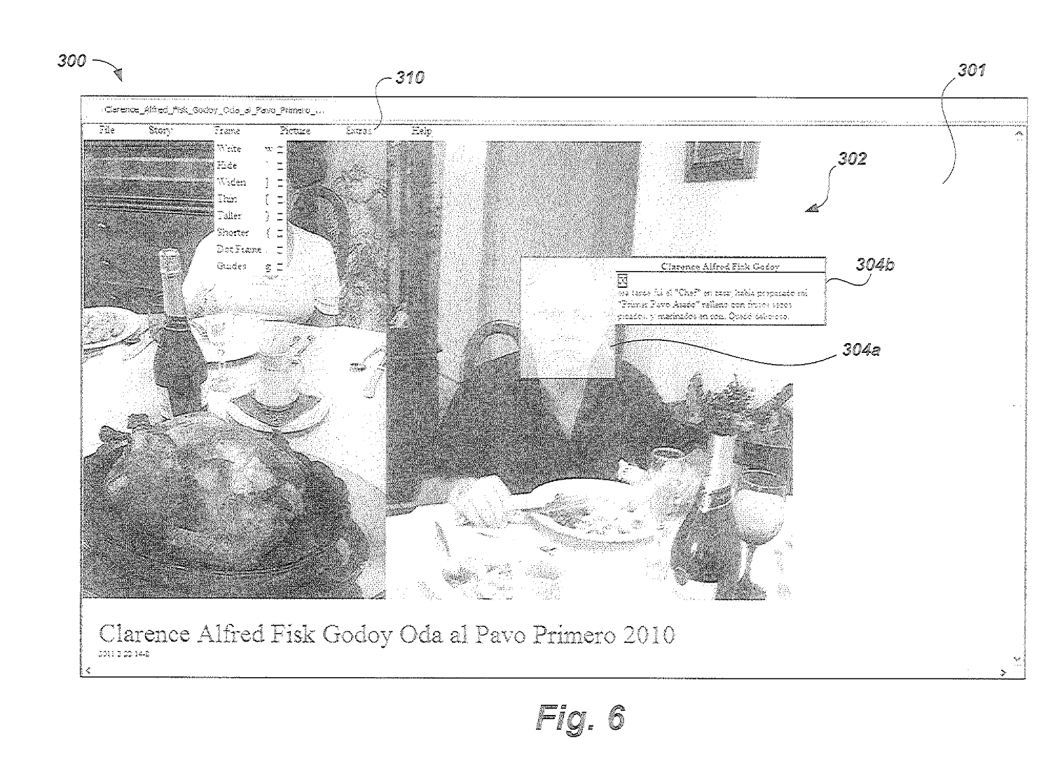

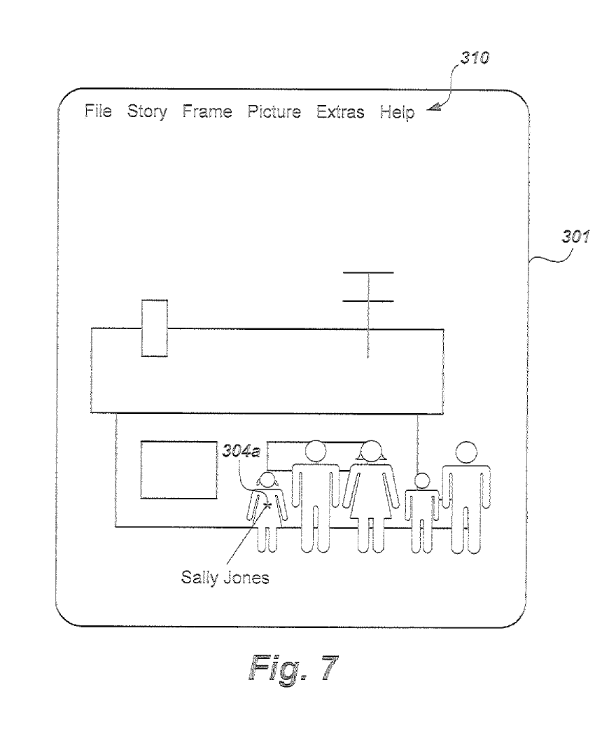

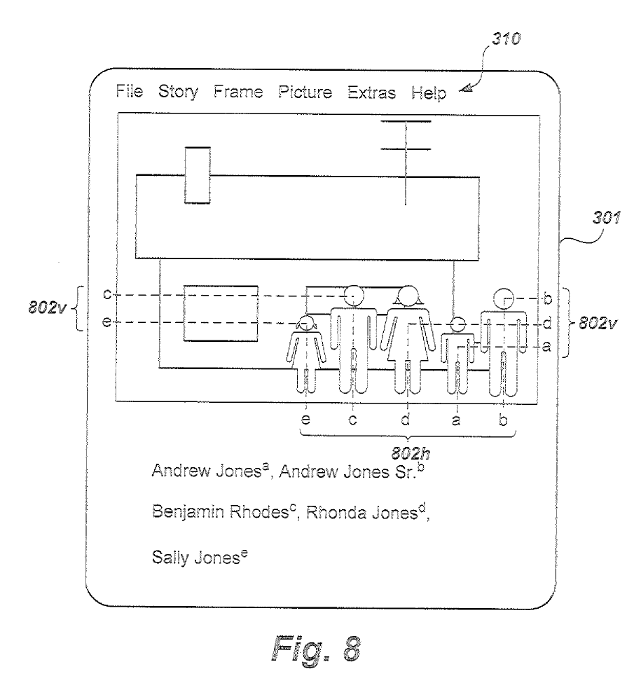

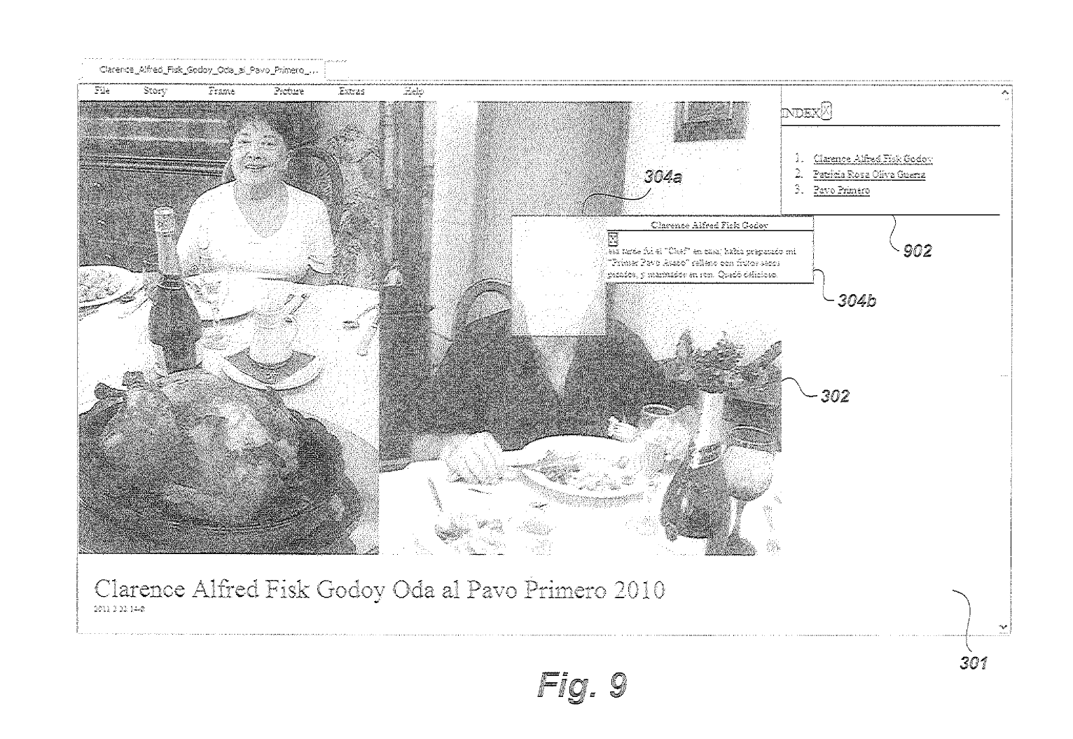

As shown in FIGS. 5 and 6, during the description process, a bounding box 304a can be defined by the user via frame pull down menu 602 and positioned over the object of interest in the digital image 302. “Name” and “About” buttons 304b are provided to allow the user to name the object of interest and to enter the description about the item of interest bounded by bounding box 304a. The pull down menu 602 allows for a variety of specifications of the bounding box height, width, properties, and the like. As shown in FIG. 7 the bounding box 304a can be reduced to a point or graticule that more finely defines the object of interest subject to the associated descriptive narrative. Moreover, the pull down menu 602 has an option to turn on or turn off guides that are placed over the image 302, the guides, as shown in FIG. 8, being an x-y coordinate grid marked with vertical indicia 802v combined with horizontal indicia 802h used to assist a user in determining a locus of a particular item of interest. When the name of the object of interest is entered, a unique combination of vertical indicia 802v and horizontal indicia 802h is defined and can be displayed as an associated superscript marking positioned next to the named specified object of interest. As shown in FIG. 9, the name field of the description in box 304b is used as an index key maintained by the system's database. When the index display box is checked, index keys are displayed in screen area 902. Commands execute using shortcut keys or the drop down menus included in tool bar 310. The tool bar view displays all commands in drop down menus. they driven commands use the keyboard; this optimizes the presentation of the image in the available screen space and is better suited for cell phones and other small Internet devices.

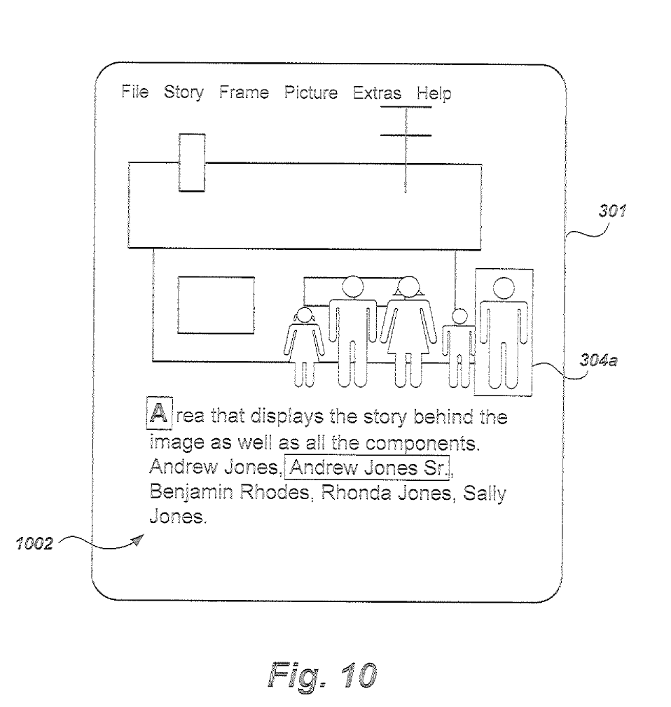

As shown in FIG. 10 the computer displays all the image information in story display area 1002. Names are displayed in bold and are links which when clicked on, cause the associated annotated image area to be highlighted by bounding box 304a.

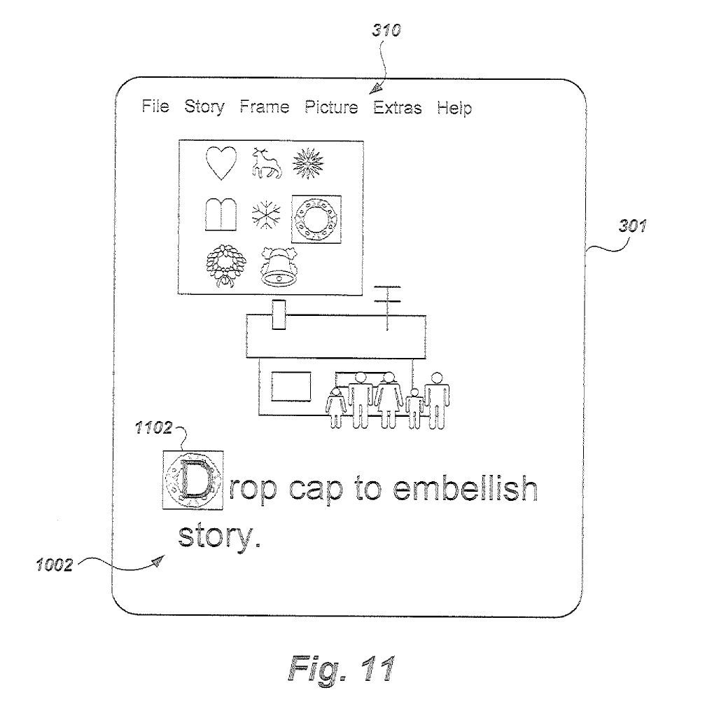

As shown in FIG. 11, drop cap designs 1102 are available, (large initial letters or words at the start of a paragraph or document), in which the user can select a drop cap design that adds user specified style and focus to the image documented in narration area 1002. Background and decoration tools are provided to enable user addition of attractive presentations to the image story. Additional processes of system 100 creates an album using the desired set of picture objects. The user designs the picture album cover by choosing a background picture, text format and color schemes. The album includes front and back covers, title, introductory page, contents page, the pictures, and a back alphabetical index of topics. Each entry in the table of contents and the alphabetized index links to a corresponding Image Object. A high-level index provides hyperlinks between related web page albums.

Component annotation and image story applications use narration area 1002 to allow the user to clearly explain, modify, or change information about any image aspect. The component annotation application allows the user to delete selected image components. The image story application allows the user to provide details as to what image was originally created, as well as details as to when, why, and where the image was originally created.

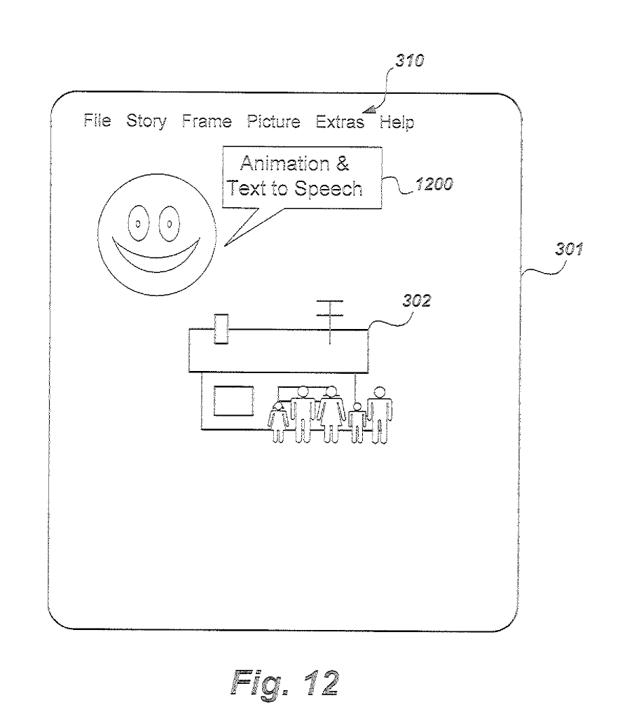

As shown in FIG. 12, the animation and text to speech optional button 1200 on web page 301 allows the user to embed animation and speech for the presentation of image descriptions using animated characters and digitized speech.

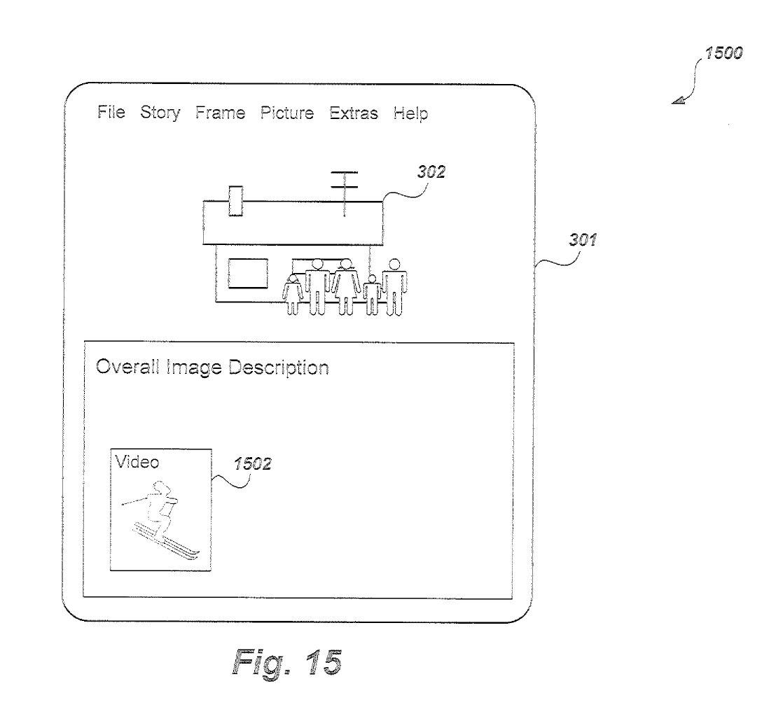

As shown in FIG. 15, the music and video button 1502 on web page 301 allows the user to embed video for the presentation of image descriptions using video to enrich the image story

As shown in FIG. 16, a Help feature 1600 is available throughout all the processes. Image Object generation 200 provides the capability of Generating new images or picture objects requires saving and running Image Object generation process 200 (having a simple HTML interface) downloaded as part of the PC Component mentioned above. Using the

HTML interface the user browses the local computer, selects an image, provides a title, and generates the corresponding Image Object 1902.

In this digital photo organizing and tagging method, albums related to other albums collect into volumes. Related volumes constitute libraries. Embellishments are available for Image Objects, albums, and libraries, animation and text-to-speech options, music, video, backgrounds, fonts, and drop caps. The digital photo organizing and tagging method prints Image Objects, albums, volume, or libraries. Moreover, the method prints using the browser print preview from other applications, such as Msystem-webosoft Word or PDF. Alternatively, the above collections print at an outside facility. Optionally, it is possible to enlarge or reduce the Image Object displayed in the computer screen. Enlarged images facilitate positioning a frame around an aspect that otherwise would de difficult to distinguish. Image enlargement and reduction allow optimal presentation and composition of the final picture object, Resizing the image keeps the aspect ratio and position of the component frames.

This application applies to users who wish to store Image Objects on the WEB Server and share and research across the Internet. Users that have installed the PC subset may or may not make use of this option. In this application, an individual using a web browser links to the main interface of the Internet Server 105, The digital photo organizing and tagging method provides data entry fields on a web page that allow new individuals to establish membership. Existing members are provided with data entry fields for signing in to the secure server 105.

As soon as a new member is accepted, the system 100 automatically creates a member directory, a folder in which to store image or picture objects. The browser provided by the computing device does selection of Image Objects and albums. The user validates the selected items and proceeds with “Submit Objects, Verify Content.”

Server administration analyzes the submitted objects for acceptable content. Rejected objects return to the sender with an explanation including recommended changes. A server global index 902 (shown in FIG. 19) appends key words extracted from the accepted objects. The server 105 stores the accepted Image Objects in the corresponding member's folder (FIG. 19).

Database 2005 maintains a global index. The global index directory contains key information for all images, ownership, and component parts. Database generator 2002 compares the newly submitted objects to those previously stored in the database and produces a list of image locations that have matching items. The owner of the newly submitted object uses the list to research previously stored images, thereby providing new relationships with the recent submissions.

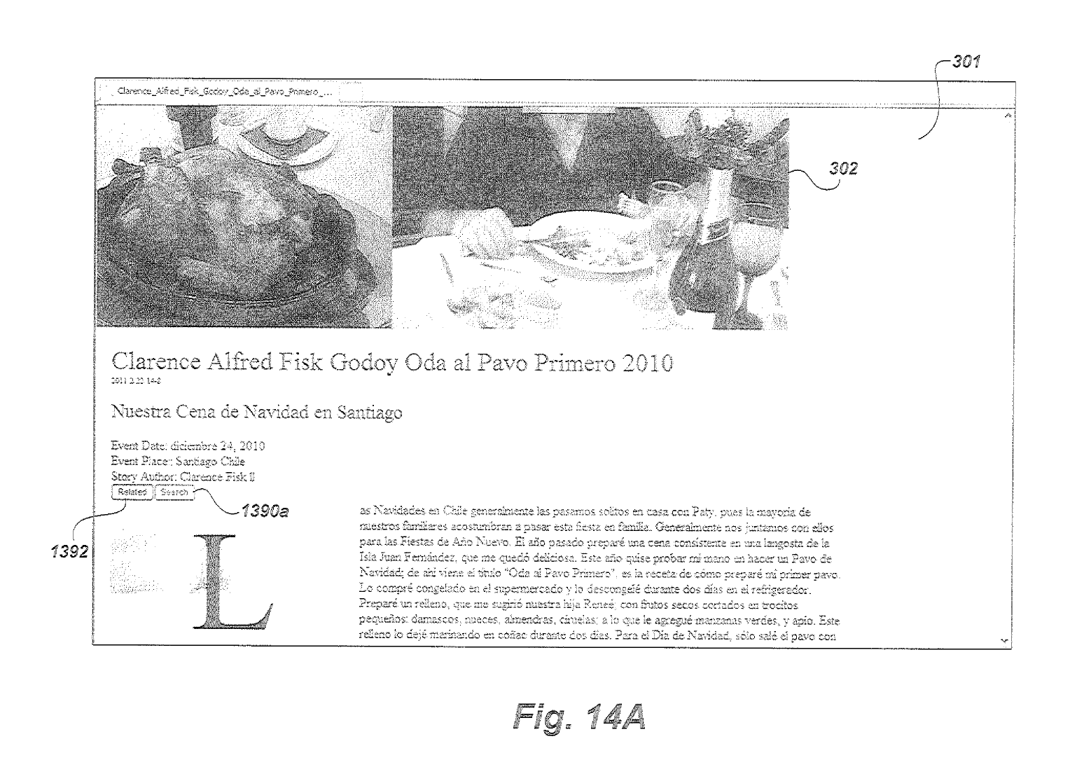

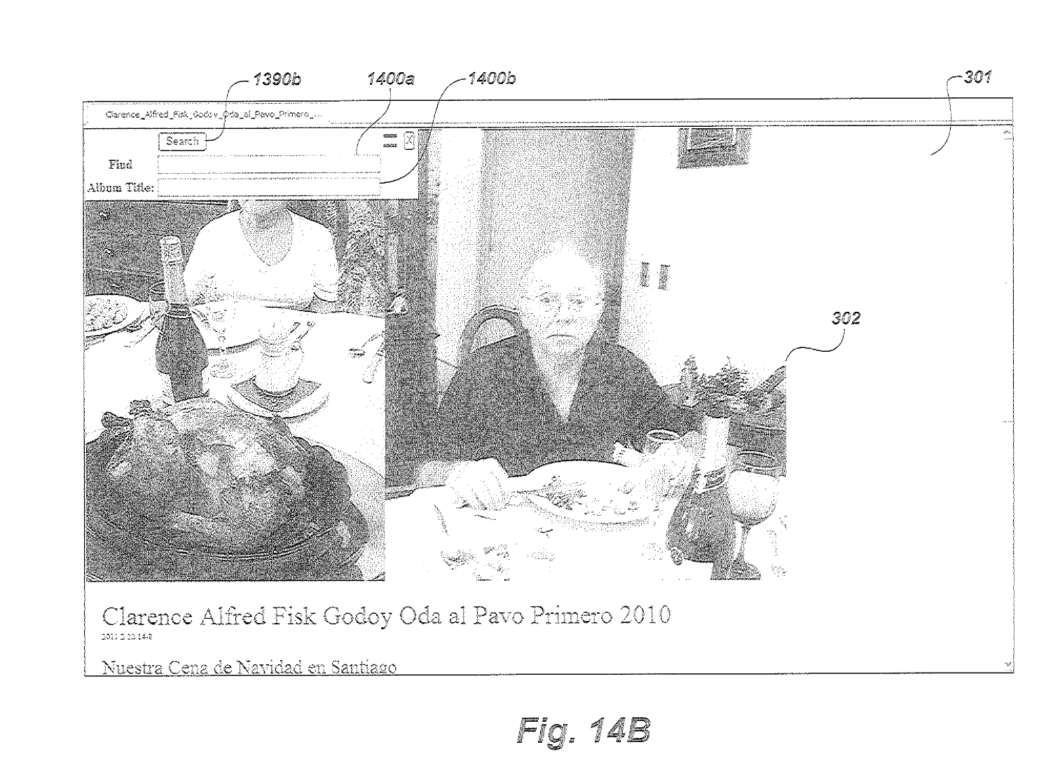

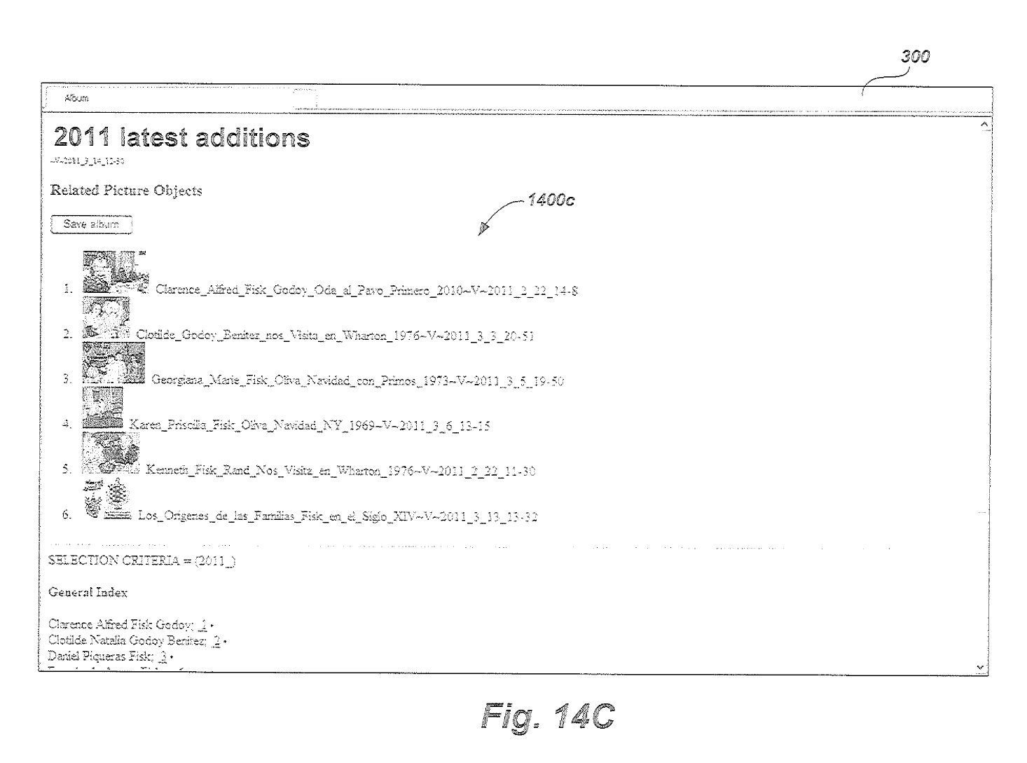

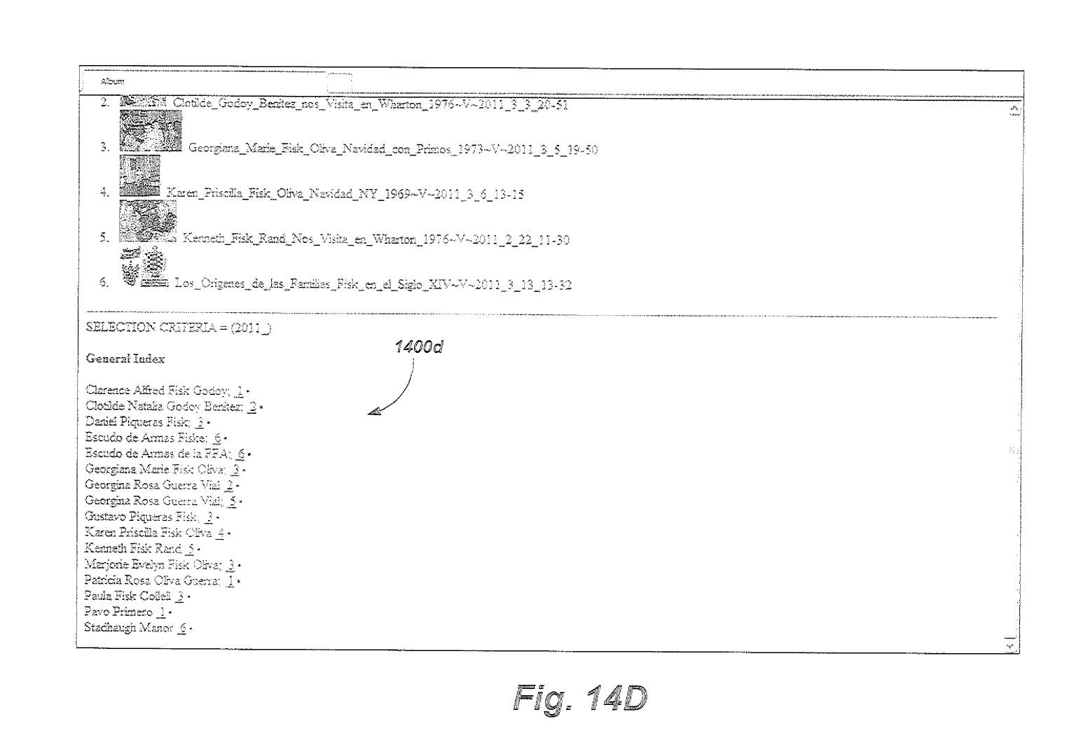

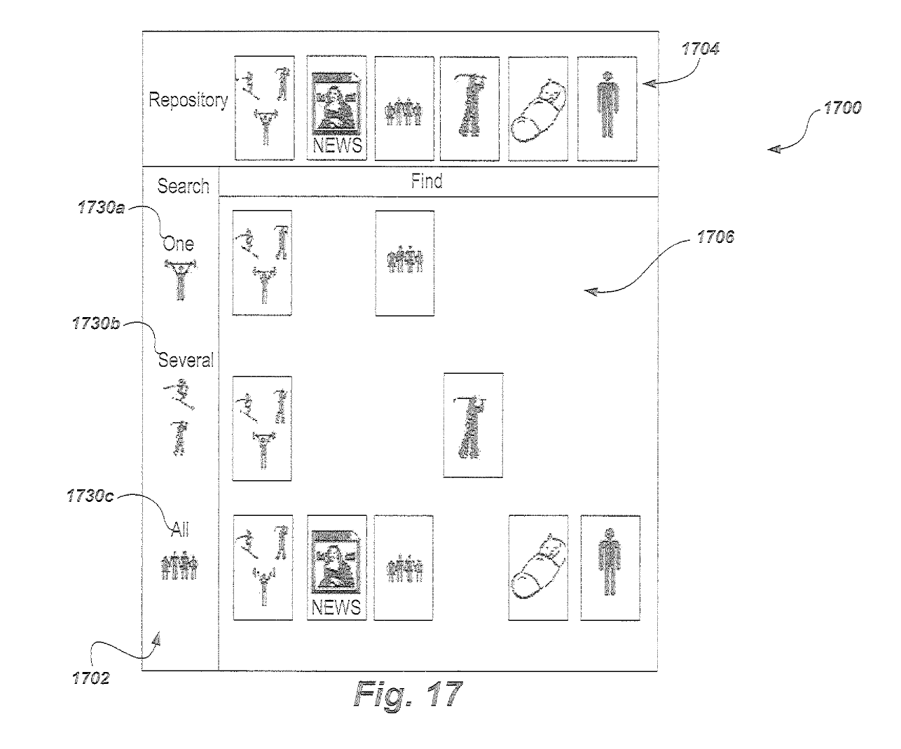

An individual using a web browser links to the main interface of the invention and selects “Run Database Search.” The search engine 1904 allows the user to search by any combination of key words, quoted sentence, period, or physical location. A pictorial view of the Image Object database organization 1700, search criteria and results is shown in FIG. 17 where top row 1704 represents images stored in the database. The left hand column represents three different selection choices 1730a, 1730b, and 1730e. The second through third rows represents the selection results 1706. After search results have been displayed, the user proceeds with “View Search Results.” As shown in FIGS. 14A-14D, search results display a hyperlinked list of in all image objects that meet the search criteria. As most clearly shown in FIG. 14A, a “Related” button 1392 and a “Search” button 1390a are provided to aid the user in searching based on either general selection criteria (“Related”) or user specified criteria (“Search”). As shown in FIG. 1413, a title or text item in the descriptive narrative may be used for search criteria. The web page provided by system 100 for such search queries includes a search button 1390 disposed above a find text entry field 1400a, which is disposed above a find album title entry field 1400b. In the exemplary web page, the text “navidad” is entered in the Find field 1 400a. The user then clicks on the search button 1390b to initiate the database query. Query results in the form of thumbnails and hyperlinks displaying related picture objects 1400c (albums, and the like) arc organized on the Search Results web page, as shown in FIG. 14C. The exemplary objects returned by database search engine have a common word, “navidad” in their description or title, Alternative to the thumbnail view, a General Index 1400d having the selection criteria (“navidad”) can be displayed, as shown in FIG. 14D. Search options include choosing one picture object (called the anchor object) as the source of data to search within all other picture objects. The key words contained in the anchor are used to select other picture objects that contain at least one key word. Moreover, the search engine 1904 contains hundreds of popular nouns. Nouns are added to the index (at the back of the album) if a searched object becomes part of the album. Searched objects become part of the album and the table of contents provided capitalized names (excluding common words that begin a sentence) exist in the anchor and the searched object.

Searched objects add to the album if anchor titles, sub-titles, places, and dates share commonality with the searched object.

The search criteria entry field permits exclusion of anchor keywords and inclusion of new words not available in the anchor. Yet another process excludes the anchor object altogether and a list of user provided keywords becomes the search criteria.

Additional methods of the selection process allow for the display of a suggested, preliminary view of the album. The system permits the user to delete one or more selected Image Objects when the user has determined that those Image Objects do not actually represent the optimal set of images. Search returns generally include thumbnails and/or index of terms, both with hyperlinks to select the Image Objects.

Clicking on a desired hyperlink displays the corresponding image on the screen of the computing device. The user can then download the desired image Objects, save them in a local PC folder, and proceed to study them. Moreover, the method provides a feature that saves new versions of the Image Objects called Child Image Objects, which inherit the elements of the original object and include new information.

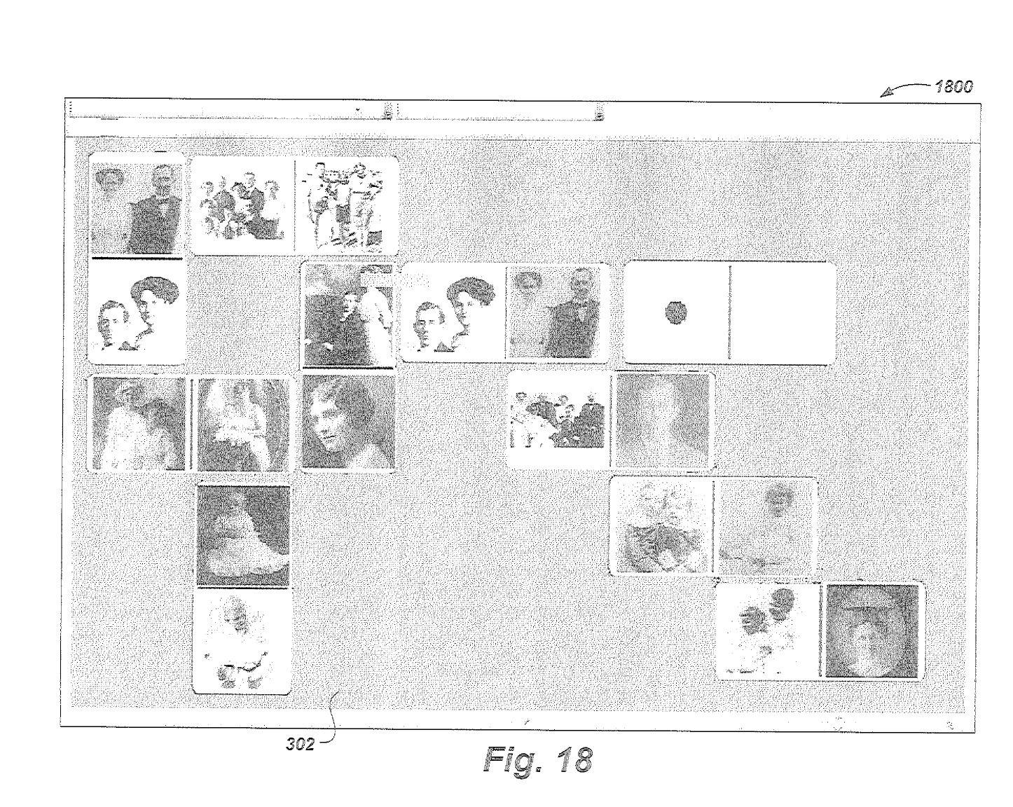

An additional feature includes the ability of the user to initiate a computer-generated random selection of key indices, which builds a table containing the randomly selected key indices. The computer then utilizes the randomly selected key indices to display in a predetermined structural pattern tagged digital image objects associated with the randomly selected key indices, Results can be a domino-like structure 1800 comprised of randomly selected images 302, as shown in FIG. 18.

It is to be understood that the present invention is not limited to the applications described above, but encompasses any and all applications within the scope of the following claims.

I claim:

1. A computer-implemented digital photo organizing and tagging method, comprising the steps of:
storing digital images into a database of computer digital images supplied by a user, thereby retaining stored digital images in the computer database;
displaying the stored digital images on a display device;
accepting into the computer database descriptions of the digital images displayed on the display device, the descriptions being supplied by the user;
tagging the digital images with the descriptions, thereby producing tagged digital image objects;
replacing in the computer database the stored digital images with e tagged digital image objects;
displaying the tagged digital image objects, including the tagging descriptions on the display device;
creating key indices in the database, the key indices being based on the descriptions and selectively associated with the tagged digital image objects according to input from the user, the key indices allowing the user to update, sort, search and arrange into digital albums the tagged digital image objects in the computer database;
randomly selecting the key indices, thereby building a set of randomly selected key indices; and
displaying in a predetermined structural pattern tagged digital image objects specified by the randomly selected key indices.

2. The computer-implemented digital photo organizing and tagging method according to claim 1, further comprising the step of playing audio information along with said displaying of said tagged digital image objects when said descriptions include an audio description of said stored digital images.

3. The computer-implemented digital photo organizing and tagging method according to claim 1, wherein said stored digital images and said tagged digital image objects include motion picture video content.

4. The computer-implemented digital photo organizing and tagging method according to claim 1, further comprising the step of embedding multimedia content in said stored digital images and said tagged digital image objects responsive to input from said user.

5. The computer-implemented digital photo organizing and tagging method according to claim 1, wherein said computer is a server computer, said user supplying said digital images and said descriptions of said digital images via a client computer in operable communication with said server computer,

6. The computer-implemented digital photo organizing and tagging method according to claim 5, wherein said client computer-server computer operable communication is via an Internet connection.

7. The computer-implemented digital photo organizing and tagging method according to claim 1, further comprising the steps of:
accepting from said user edits of said tagged digital image objects; and
updating said tagged digital image objects according to said user edits.

8. The computer-implemented digital photo organizing and tagging method according to claim 1, further comprising the steps of:
providing a help function to said user; and
providing error detection and warning messages to said user.

9. The computer-implemented digital photo organizing and tagging method according to claim 1, wherein a portion of said descriptions of said digital images forms a story associated with said digital images, the story being displayed in proximity to said digital images on said display device.

10. The computer-implemented digital photo organizing and tagging method according to claim I, further comprising the step of granting access to said database based on membership status of said user.

11. The computer-implemented digital photo organizing and tagging method according to claim I, further comprising the step of causing said key indices to be displayed in the form of key words on said display device.

12. The computer-implemented digital photo organizing and tagging method according to claim 11, further comprising the steps of:
accepting user entry of combinations of said key words;
returning groups of said stored digital images and said tagged digital image objects based on matching criteria associated with said combinations of said key words; and
displaying said groups of said stored digital images and said tagged digital image objects responsive to selection by said user.

13. The computer-implemented digital photo organizing and tagging method according to claim 12, further comprising the step of overlaying an x-y grid on top of said tagged digital image objects, said x-y grid having coordinate indicia pinpointing a visual center of each individual one of said tagged digital image objects being displayed.

14. The computer-implemented digital photo organizing and tagging method according to claim 13, further comprising the step of providing multiple user access to said tagged digital image objects based on permissions granted by said user.

15. The computer-implemented digital photo organizing and tagging method according to claim 13, wherein said tagging step further comprises the step of placing a sizable bounding box over a user designated portion of said digital images to define a locus of a specific one of said tagged digital image objects to be associated with a respective specific one of said descriptions.

16. The computer-implemented digital photo organizing and tagging method according to claim 13, further comprising the step of collecting related said tagged digital image objects into a digital album.

17. The computer-implemented digital photo organizing and tagging method according to claim 13, wherein said tagging said digital images with said descriptions further comprises the step of accepting from said user a title name as a key entry associated with a new said digital images.

18. The computer-implemented digital photo organizing and tagging method according to claim 17, further comprising the step of accepting entry of foreign language character types otherwise not available on said user's data entry device.

19. The computer-implemented digital photo organizing and tagging method according to claim 17, further comprising the step of email distributing user selected said digital images to recipients designated by said user.

20. The computer-implemented digital photo organizing and tagging method according to claim 17, further comprising the steps of:
assembling a plurality of albums related by a first common key into a volume of said related plurality of albums;
displaying a volume access hyperlink that accesses said volume of said related plurality of albums;
forming a first index comprised of at least one said volume access hyperlink, said first index facilitating user selection of a desired said volume;
assembling a plurality of volumes related by a second common key into a library of said related plurality of volumes;
displaying a library access hyperlink that accesses said library of said related plurality of volumes; and
forming a second index having at least one said library access hyperlink, the second index facilitating user selection of a desired said library.
